(19) United States
(12) Patent Application Publication
(10) Pub. No.: US 2007/0058050 A1
(43) Pub. Date: Mar. 15, 2007

(54) Reconstructing a full color image from an image encoded by a bayer pattern

(76) Inventor: Manuel Innocent, Wezemaal (BE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/225,496

(22) Filed: Sep. 12, 2005

(51) Int. Cl. H04N 5/228

(52) U.S. Cl. 348/222.1

(57) ABSTRACT

A method and apparatus for reconstructing a full color image. The method may include receiving a signal pertaining to an encoded image, and reconstructing four color values for each pixel location in the image using a set of convolution masks.

### TECHNICAL FIELD

The present invention relates generally to electronic imaging and, more particularly, to reconstructing a full color image from an image encoded by a Bayer pattern.

### BACKGROUND

Solid-state image sensors have found widespread use in camera systems. The solid-state image sensors in some camera systems are composed of a matrix of photosensitive elements in series with switching and amplifying elements. The photosensitive elements may be, for example, photoreceptors, photo-diodes, phototransistors, charge-coupled device (CCD) gate, or alike. Each photosensitive element receives an image of a portion of a scene being imaged. A photosensitive element along with its accompanying electronics is called a picture element or pixel. The image obtaining photosensitive elements produce an electrical signal indicative of the light intensity of the image. The electrical signal of a photosensitive element is typically a current, which is proportional to the amount of electromagnetic radiation (light) falling onto that photosensitive element.

In a color image sensor, the photosensitive elements are typically overlaid by a color filter array (CFA) such that each pixel yields only one color component (red, green or blue). The result is a mosaic of color samples such as one known as a Bayer array. In the Bayer geometry, the kernel (the smallest repetitive pattern in the array) consists of a red pixel, a blue pixel and two green pixels. The process to generate all color components for each pixel in a color image is a reconstruction process called demosaicing.

Most demosacing algorithms used for images encoded by a Bayer pattern treat the two green pixels in the Bayer kernel as if they have the same response. However, because the two green pixels often do not have the same response, such techniques lead to artifacts in the full color images.

There are some demosaicing algorithms that allow the two green pixels in the Bayer kernel to have different responses. However, these demosaicing algorithms are typically complex and require an additional algorithm for adjusting the sharpness of the full color image, which involves a substantial amount of computation.

### BRIEF DESCRIPTION OF THE DRAWINGS

The present invention is illustrated by way of example, and not by way of limitation, in the figures of the accompanying drawings in which:

FIG. 1 is a flow diagram of one embodiment of a demosaicing process;

FIG. 2 is a flow diagram of one embodiment of a process for reconstructing four color values for a pixel location in an image encoded by a Bayer pattern;

FIG. 3 illustrates various degrees of sharpness in images produced using the method of FIG. 2;

FIGS. 4A and 4B illustrate the quality of an image produced using the method of FIG. 2; and

FIG. 5 is a block diagram of one embodiment of an image sensor.

### DETAILED DESCRIPTION

In the following description, numerous specific details are set forth, such as examples of specific commands, named components, connections, number of frames, etc., in order to provide a thorough understanding of embodiments of the present invention. It will be apparent, however, to one skilled in the art that embodiments of present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

Some portions of the description that follow are presented in terms of algorithms and symbolic representations of operations on data that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

The following detailed description includes algorithms, which will be described below. These algorithms may be implemented by hardware (e.g., analog and/or digital), firmware, or software as embodied in machine-executable instructions, which may be used to cause a general-purpose or special-purpose processor programmed with the instructions to perform the operations described herein. Alternatively, the operations may be performed by a combination of hardware, firmware, and software. The term “coupled to” as used herein may mean coupled directly to or indirectly to through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines, and each of the single signal lines may alternatively be buses. The terms “first,” “second” “third” and “fourth” as used herein are meant as labels to distinguish among different pixels and/or different colors and do not have an ordinal meaning according to their numerical designation unless otherwise noted.

A method and apparatus for reconstructing a full color image is described. Although the reconstruction methods and apparatus are discussed at times as part of a color image sensor, they can also be part of an independent device coupled to the color image sensor.

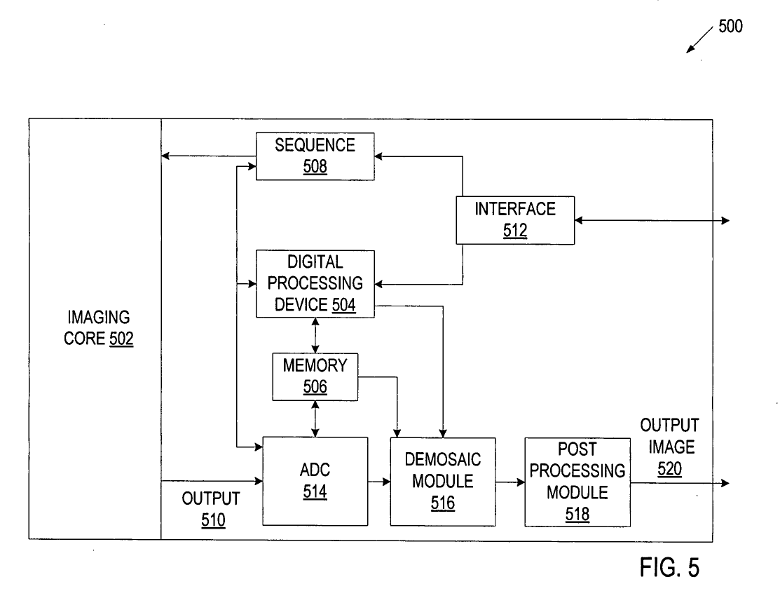

A color image sensor (e.g., image sensor 500 discussed below in relation to FIG. 5) may be used to sample the color spectrum using, in one embodiment, a charge-coupled device (CCD) array overlaid by a color filter array (CFA) such that each pixel samples only one color channel (i.e., every pixel only records one color instead of three). The result is a mosaic of color samples such as one referred to as a Bayer pattern. The Bayer pattern scheme results in 25% red, 25% blue and 50% green coverage of the pixel matrix. That is, in the Bayer geometry, the kernel (the smallest repetitive pattern in the array) consists of a red pixel, a blue pixel and two green pixels. It should be noted that although embodiments of the present invention may be discussed at times in relation to a Bayer pattern, the method and apparatus described herein may be adapted for use with various other types of color mosaics schemes, for example, any mosaic schemes in which the kernel includes two pixels of the same color or pixels of four different colors.

When reconstructing a full color image, all three color (red, green and blue) values are estimated for each sensor location based on the source pixel at the relevant sensor location and the nearby source pixels. In the Bayer kernel, the two green pixels appear in different configurations (e.g., with different neighbors, different cross-talk, etc.). As such, the two green pixels may have different responses. Embodiments of the present invention account for such differences by reconstructing four color (red, green1, green2 and blue) values for each sensor location. The reconstruction is performed using a set of convolution masks that are parameterized to allow for adjustment of sharpness during image reconstruction.

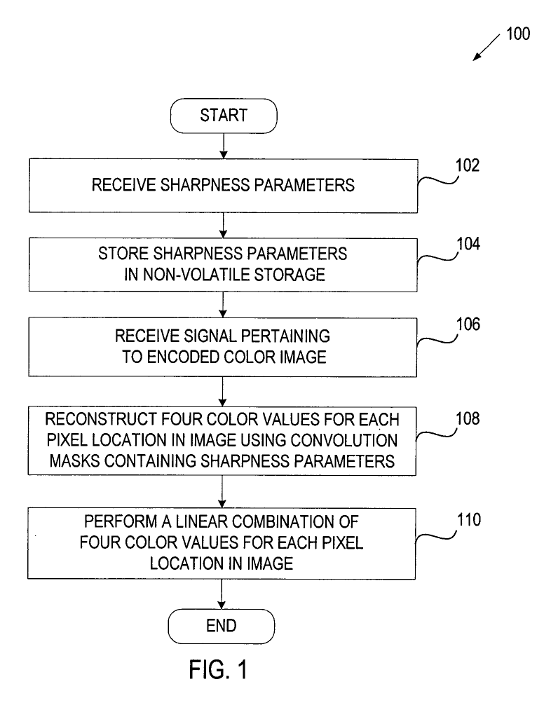

FIG. 1 is a flow diagram of one embodiment of a demosaicing process 100. The process may be performed by processing logic of a demosaic module (e.g., demosaic module 516 discussed below in conjunction with FIG. 5) and may comprise hardware (e.g., circuitry, dedicated logic, programmable logic, microcode, etc.), software (such as run by a digital processing device or a general purpose computer system), or a combination of both.

Referring to FIG. 1, processing logic begins with processing logic receiving sharpness parameters (block 102). In one embodiment, the sharpness parameters may be provided by a user during the configuration phase to define the sharpness of resulting images. The user may specify the desired degree of sharpness (e.g., smooth, normal, sharp, very sharp, etc.) that may be programmatically converted into corresponding sharpness parameters. Alternatively, the user may provide specific values for the sharpness parameters.

In another embodiment, sharpness parameters are not specified by the user but rather automatically determined based on the type of application for which method 100 is used (e.g., general-purpose photography or special-purpose photography).

At block 104, processing logic stores the sharpness parameters in a non-volatile storage (e.g., NVRAM of image sensor 500 discussed below in relation to FIG. 5) for subsequent use in the image reconstruction. In one embodiment, the sharpness parameters may be updated based on a user request.

At block 106, processing logic receives a signal pertaining to an encoded color image having one color value for each pixel location. In one embodiment, the signal includes pixel values of an image encoded using a 2 by 2 pattern including two pixels of the same color (e.g., the Bayer pattern). Alternatively, the 2 by 2 pattern includes pixels of four different colors.

At block 108, processing logic reconstructs four color values for each pixel location in the image. In one embodiment, the four color values include a red value R, a blue value B, a first green value G1 and a second green value G2 (e.g., according to the Bayer pattern). Alternatively, the reconstructed color values may include B, G, R1 and R2; R, G, B1 and B2; or four different colors (e.g., B, G, R and brown).

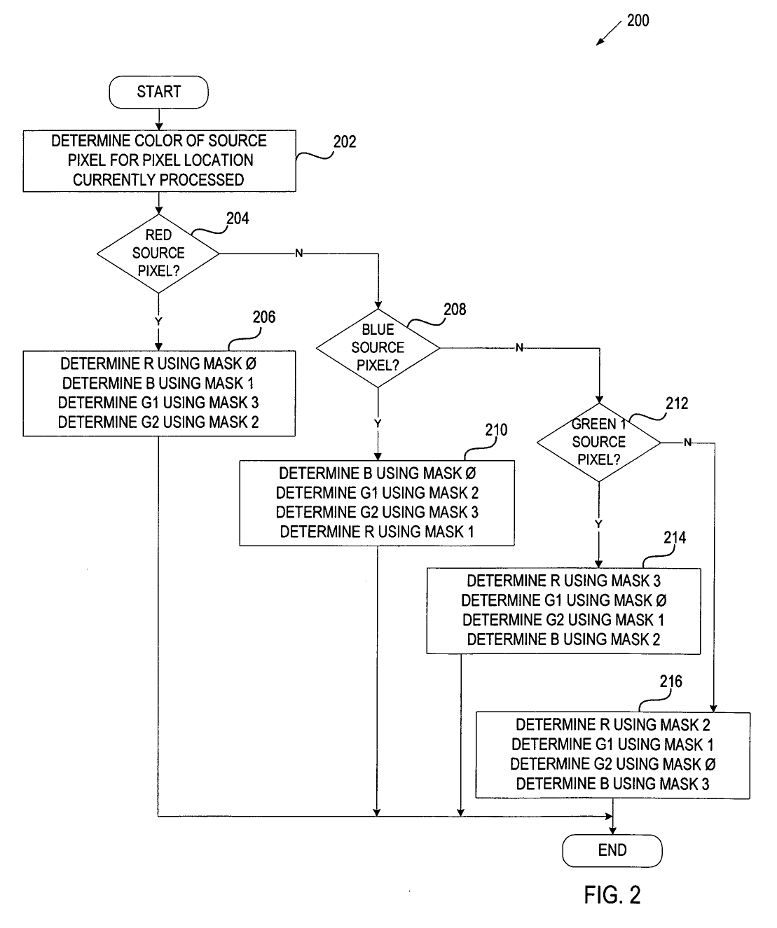

The four color values are reconstructed using a set of convolution masks that contain sharpness parameters retrieved from the non-volatile storage. The set of masks being used is the same for each pixel location, regardless of the color of the corresponding source pixel. The size of the convolution masks and their coefficients may be determined experimentally based on the application type for which method 100 is used. One embodiment of a reconstruction process utilizing a set of 4 convolution masks is discussed in greater detail below in conjunction with FIG. 2.

In one embodiment, processing logic performs reconstruction in parallel for two pixels—a current pixel and a pixel on the same pixel column from the previous pixel line.

At processing block 110, processing logic performs a linear combination of the reconstructed four pixel values for each pixel location in the image to produce an output three-color image. In one embodiment, the average of two pixel values of the same color is calculated to determine a pixel value of this color in the output image (e.g., the green value in the output image is the average of the reconstructed G1 and G2).

FIG. 2 is a flow diagram of one embodiment of a process 200 to reconstruct four color values for a pixel location in an image encoded by the Bayer pattern. The process may be performed by processing logic of a demosaic module (e.g., demosaic module discussed below in conjunction with FIG. 5) and may comprise hardware (e.g., circuitry, dedicated logic, programmable logic, microcode, etc.), software (such as run by a digital processing device or a general purpose computer system), or a combination of both.

Process 200 uses a set of four convolution masks. Exemplary convolution masks containing sharpness parameters a and b are as follows:

| mask0 = [ | | | | | |
|---|---|---|---|---|---|
| 0 | 0 | 0 | 0 | 0 | |
| 0 | 0 | 0 | 0 | 0 | |
| 0 | 0 | 8 | 0 | 0 | |
| 0 | 0 | 0 | 0 | 0 | |
| 0 | 0 | 0 | 0 | 0 | ] |
| mask1 = [ | | | | | |
| 0 | 0 | −a/4 | 0 | 0 | |
| 0 | 2 | 0 | 2 | 0 | |
| −a/4 | 0 | a | 0 | −a/4 | |
| 0 | 2 | 0 | 2 | 0 | |
| 0 | 0 | −a/4 | 0 | 0 | ] |
| mask2 = [ | | | | | |
| 0 | 0 | −b/2 | 0 | 0 | |
| 0 | 0 | 4 | 0 | 0 | |
| 0 | 0 | b | 0 | 0 | |
| 0 | 0 | 4 | 0 | 0 | |
| 0 | 0 | −b/2 | 0 | 0 | ] |
| mask3 = [ | | | | | |
| 0 | 0 | 0 | 0 | 0 | |
| 0 | 0 | 0 | 0 | 0 | |
| −b/2 | 4 | b | 4 | −b/2 | |
| 0 | 0 | 0 | 0 | 0 | |
| 0 | 0 | 0 | 0 | 0 | ] |

Experiments were conducted to determine the optimal size of the above masks and their coefficients.

Referring to FIG. 2, processing logic begins with determining the color of a source pixel corresponding to the pixel location being currently processed (block 202).

If the source pixel is red (block 204), processing logic determines the red value R using mask0, the blue value B using mask1, the first green value G1 using mask3, and the second green value G2 using mask2 (processing block 206). In particular, the four color values of the pixel location corresponding to the red source pixel are determined as follows:
Result_R=1/8* Conv(mask0, memory);
Result_G1=1/8* Conv(mask3, memory);
Result_G2=1/8* Conv(mask2, memory);
Result_B=1/8* Conv(mask1, memory);
   where “memory” refers to stored pixel values of the source pixel and its neighbors in a 5 by 5 region, in which the current source pixel is the center.

If the source pixel is blue (block 208), processing logic determines the red value R using mask1, the blue value B using mask0, the first green value G1 using mask2, and the second green value G2 using mask3 (processing block 210). In particular, the four color values of the pixel location corresponding to the blue source pixel are determined as follows:
Result_B=1/8* Conv(mask0, memory);
Result_G1=1/8* Conv(mask2, memory);
Result_G2=1/8* Conv(mask3, memory);
Result_R=1/8* Conv(mask1, memory).

If the source pixel is a first green pixel (block 212), processing logic determines the red value R using mask3, the blue value B using mask2, the first green value G1 using mask0, and the second green value G2 using mask1 (processing block 214). In particular, the four color values of the pixel location corresponding to the first green source pixel are determined as follows:
Result_R=1/8* Conv(mask3, memory);
Result_G1=1/8* Conv(mask0, memory);
Result_G2=1/8* Conv(mask1, memory);
Result_B=1/8* Conv(mask2, memory).

If the source pixel is a second green pixel, processing logic determines the red value R using mask2, the blue value B using mask3, the first green value G1 using mask1, and the second green value G2 using mask0 (processing block 216). In particular, the four color values of the pixel location corresponding to the second green source pixel are determined as follows:
Result_R=1/8* Conv(mask2, memory);
Result_G1=1/8* Conv(mask1, memory);
Result_G2=1/8* Conv(mask0, memory);
Result_B=1/8* Conv(mask3, memory).

The sharpness parameters a and b in the convolution masks allow adjusting the sharpness of the full color image during reconstruction, thus eliminating a separate sharpening module. Small values for a and b lead to a smooth image, large values lead to a sharp image.

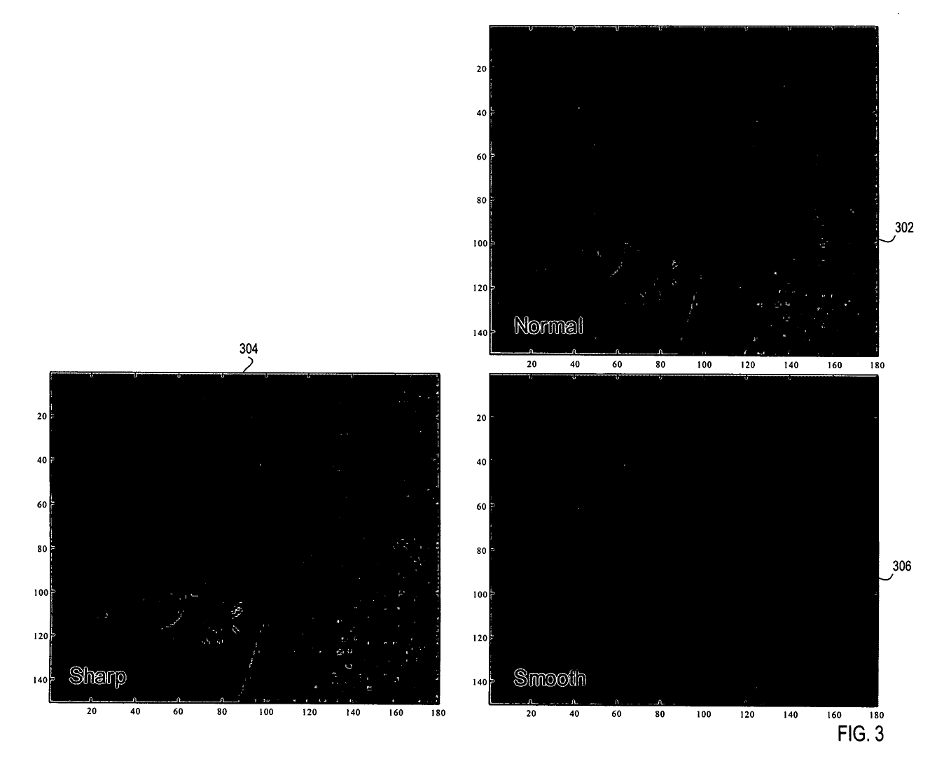

FIG. 3 illustrates various degrees of sharpness in images produced using method 200. Image 302 having an average sharpness is produced using medium values for sharpness parameters a and b in the convolution masks. Image 304 is a sharp image produced using large values for sharpness parameters a and b in the convolution masks. Image 306 is a smooth image produced using small values for sharpness parameters a and b in the convolution masks.

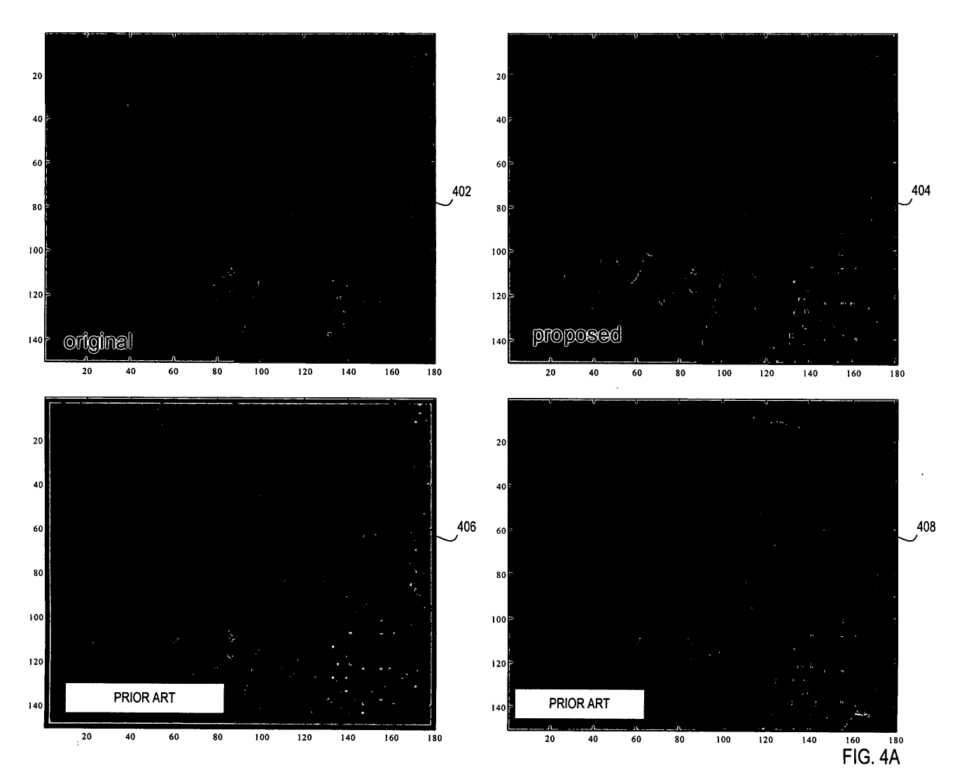

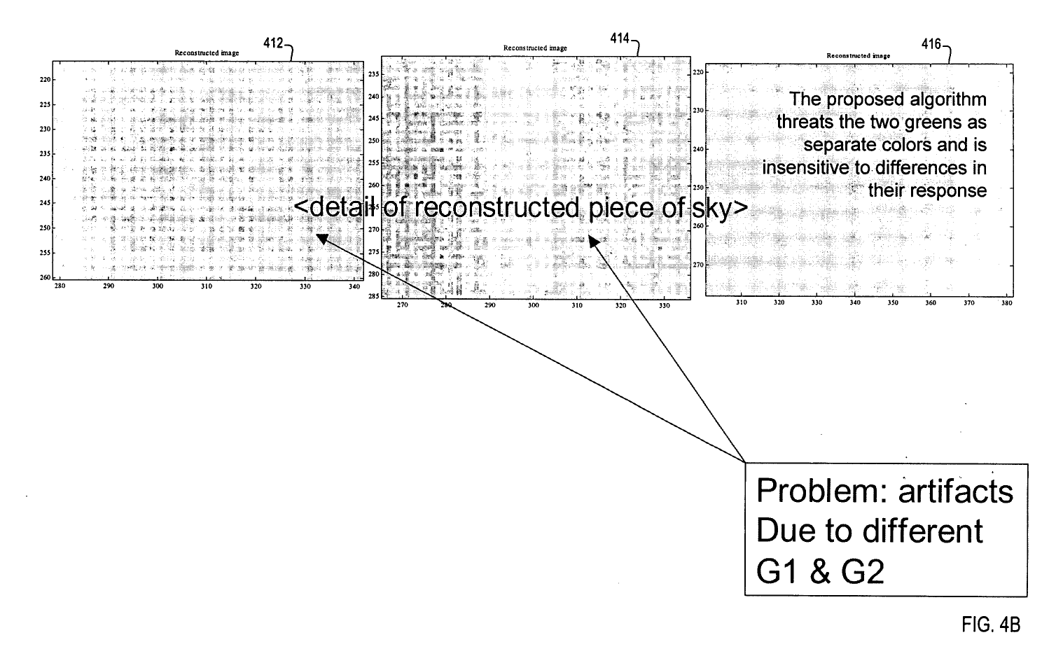

FIGS. 4A and 4B illustrate the quality of images produced using method 200. Referring to FIG. 4A, image 402 is an original 3-color image used as a reference for the comparison with images 404, 406 and 408. The original image 402 is encoded using the Bayer pattern by removing 2 of the 3 color values for each pixel location according to the Bayer pattern. This encoded image is used as input to color image reconstruction methods illustrated in FIG. 4A. Image 404 is a color image reconstructed using method 200. Images 406 and 408 are color images reconstructed using prior art methods. In particular, the method used to reconstruct the image 406 (referred to herein as the Hamilton-Adams method) is described in the U.S. Pat. No. 5,629, 734; and the method used to reconstruct the image 408 (referred to herein as the Malvar method) is described in the publication of H. S. Malvar et al., “High-Quality Linear Interpolation for Demosaicing of Bayer-Patterned Color Images”, Proceedings of IEEE ICASPP 2004.

As shown in FIG. 4A, the image 404 reconstructed using method 200 has better quality than the image 406 reconstructed using the Hamilton-Adams method. In particular, the image 406 has significantly more artifacts (e.g., in the area of eyelashes) than the image 406. The image 408 reconstructed using the Malvar method looks similar to the image 404 because in the illustrated example the 2 greens in the Bayer kernel were generated from the same green in the image 402 and as such have the same response. However, if the two greens had different responses, the Malvar method would introduce block pattern artifacts. In addition, neither the Hamilton-Adams method nor the Malvar method allows choosing the sharpness of the reconstructed image during color reconstruction.

Referring to FIG. 4B, images 412, 414 and 416 show details of a reconstructed piece of sky. The image 412 was generated using the Malvar method, the mage 414 was generated using the Hamilton-Adams method and the image 416 was generated method 200 discussed above. As shown in FIG. 4B, the image 416 has a significantly better quality as compared to images 412 and 414 that include noticeable artifacts due to different responses of the green pixels.

FIG. 5 is a block diagram of one embodiment of an image sensor 500 implementing the methods and apparatus described herein. Image sensor 500 includes an imaging core 502 with a pixel matrix in series with switching and amplifying elements. The pixel matrix has an array of pixels and the corresponding driving and sensing circuitry. Each pixel is composed of at least a photosensitive element and a readout switch. A pixel matrix and switching and amplifying elements are known in the art; accordingly, a more detailed description is not provided.

The imaging core provides an analog output 510 to an analog-to-digital converter (ADC) 514 to convert the analog imaging core output 510 into the digital domain. The ADC 514 is coupled to a digital processing device 504. The digital processing device 504 may include one or more general-purpose processing devices such as a microprocessor or central processing unit, a controller, or the like. Alternatively, digital processing device 504 may include one or more special-purpose processing devices such as a digital signal processor (DSP), an application specific integrated circuit (ASIC), a field programmable gate array (FPGA), or the like. Digital processing device 504 may also include any combination of a general-purpose processing device and a special-purpose processing device.

The digital processing device 504 is coupled to an interface module 512 that handles the information input/output (I/O) exchange with components external to the image sensor 500 and takes care of other tasks such as protocols, handshaking, voltage conversions, etc. The interface module 512 may be coupled to a sequencer 508. The sequencer 508 may be coupled to one or more components in the image sensor 500 such as the imaging core 502, digital processing device 504, and ADC 514. The sequencer 508 may be a digital circuit that receives externally generated clock and control signals from the interface module 512 and generates internal pulses to drive circuitry in the imaging sensor for example, the imaging core 502, ADC 514, etc.

The digital processing device 504 is coupled to a memory 506. Memory 506 can be any type of machine medium readable by the digital processing device 504. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards), or any type of media suitable for storing electronic instructions.

In one embodiment, memory 506 includes non-volatile memory (e.g., NVRAM or flash memory) to store sharpness parameters. In addition, memory 506 may include RAM to temporarily store the output of the ADC 514 (e.g., color values of source pixels of an image encoded using the Bayer pattern).

The image sensor 500 may also include a demosaic module 516. In one embodiment, the demosaic module 516 resides in memory 506 and contains processing logic for execution by the digital processing device 504. In another embodiment, the demosaic module 516 is an independent block containing processing logic that comprises hardware such as circuitry, dedicated logic, programmable, logic, microcode, etc. In yet another embodiment, the demosaic module 516 contains processing logic that comprises a combination of software and hardware.

In one embodiment, the demosaic module 516 receives individual source pixels from the ADC 514 and accesses memory 506 to read pixels in the neighborhood of the current source pixel. The demosaic module 516 then reconstructs four color values for the current source pixel using a set of parameterized convolution masks. In one embodiment, the demosaic module 516 performs reconstruction in parallel for two pixels—a current pixel and a pixel on the same pixel column from the previous pixel line.

The demosaic module 516 may also adjust the sharpness of the reconstructed image based on sharpness parameters in the convolution masks. The demosaic module 516 may then perform a linear combination of the four color values and provide a resulting three-color image to a post-processing module 518. In the post-processing module 518, the output of the demosaicing goes through a series of image processing steps such as color correction, halftoning, white balancing and compression, and is finally output to the image output 520 (e.g., for a display device, a recording unit, etc.). The post-processing module 518 may reside in memory 506 and contain processing logic for execution by the digital processing device 504, or be an independent block containing processing logic that comprises hardware, or yet contain processing logic that comprises a combination of software and hardware.

The image sensor 500 discussed herein may be used in various applications. In one embodiment, the image sensor 500 discussed herein may be used in a digital camera system, for example, for general-purpose photography (e.g., camera phone, still camera, video camera) or special-purpose photography. Alternatively, the image sensor 500 discussed herein may be used in other types of applications, for example, machine vision, document scanning, microscopy, security, biometry, etc.

While some specific embodiments of the invention have been shown, the invention is not to be limited to these embodiments. The invention is to be understood as not limited by the specific embodiments described herein, but only by scope of the appended claims.

What is claimed is:

1. A method comprising:
receiving a signal pertaining to an encoded image having one color value for each pixel location, the image being encoded according to a two by two pattern comprising four pixels of a plurality of colors; and
reconstructing four values of the plurality of colors for each pixel location in the image using a set of convolution masks,
wherein the same set of convolution masks is used for reconstruction of every color, and the order of the convolution masks being used depends on the color of a corresponding pixel in the encoded image.

2. The method of claim 1 wherein the plurality of colors include three colors.

3. The method of claim 2 wherein the pattern comprises a Bayer pattern including two green pixels, one red pixel and one blue pixel.

4. The method of claim 1 further comprising:
performing a linear combination of the four color values of each pixel location to produce an output three-color image.

5. The method of claim 1 wherein coefficients in the set of convolution masks include one or more parameters.

6. The method of claim 5 wherein the one or more parameters are specified by a user.

7. The method of claim 5 further comprising:
adjusting a sharpness of the image based on the one or more parameters.

8. The method of claim 1 wherein:
the set of convolution masks includes four convolution masks.

9. The method of claim 1 wherein the four color values of each pixel location are reconstructed based on a pixel value of a current source pixel and neighbors of the current source pixel in a five by five region, in which the current source pixel is the center.

10. An apparatus comprising:
a memory to store color values of source pixels of an image encoded using a two by two pattern comprising four pixels of a plurality of colors; and
a demosaic module to reconstruct four values of the plurality of colors for each pixel location in the image using a set of convolution masks,
wherein the same set of convolution masks is used for reconstruction of every color, and the order of the convolution masks being used depends on the color of a corresponding pixel in the encoded image.

11. The apparatus of claim 10 wherein the pattern comprises two green pixels combined with a red pixel and a blue pixel.

12. The apparatus of claim 11 wherein the pattern comprises a Bayer pattern.

13. The apparatus of claim 11 wherein the demosaic module is further to perform a linear combination of the four color values of each pixel location to produce an output three-color image.

14. The apparatus of claim 11 wherein coefficients in the set of convolution masks include one or more parameters.

15. The apparatus of claim 14 wherein the demosaic module is further to adjust a sharpness of the image based on the one or more parameters.

16. The apparatus of claim 11 wherein the demosaic module is to select a convolution mask from the set for one of the four color values based on a pixel value of a current source pixel and neighbors of the current source pixel in a five by five region, in which the current source pixel is the center.

17. A machine-readable medium containing instructions which, when executed by a processing system, cause the processing system to perform a method comprising:
receiving a signal pertaining to an encoded image having one color value for each pixel location, the image being encoded according to a two by two pattern comprising four pixels of a plurality of colors; and
reconstructing four color values of the plurality of colors for each pixel location in the image using a set of convolution masks,
wherein the same set of convolution masks is used for reconstruction of every color, and the order of the convolution masks being used depends on the color of a corresponding pixel in the encoded image.

18. The machine-readable medium of claim 17 wherein the pattern comprises two green pixels combined with a red pixel and a blue pixel.

19. The machine-readable medium of claim 18 wherein the pattern comprises a Bayer pattern.

20. The machine-readable medium of claim 17 wherein the method further comprises:
adjusting a sharpness of the image based on one or more parameters contained in the set of convolution masks.
